(19) United States
(12) Patent Application Publication
(10) Pub. No.: US 2018/0212935 A1
(43) Pub. Date: Jul. 26, 2018

(54) METHOD AND SYSTEM FOR OFFLINE PLAYBACK OF MULTIMEDIA FILES PROTECTED WITH DIGITAL RIGHTS MANAGEMENT SCHEME

(71) Applicant: ANI Technologies Private Limited, Bengaluru (IN)

(72) Inventors: Sriram V Iyer, Bengaluru (IN); Vasuki K Setlur, Bengaluru (IN); Arun Samudrala, Bengaluru (IN); Ankit Bhati, Bengaluru (IN); Shadab Siddiqui, Lucknow (IN)

(21) Appl. No.: 15/875,266

(22) Filed: Jan. 19, 2018

(30) Foreign Application Priority Data
Jan. 20, 2017 (IN) 2017 4100 2271
Dec. 29, 2017 (IN) 201741002271

(51) Int. Cl. H04L 29/06; G06F 12/14; H04L 9/08; G06F 21/60

(52) U.S. Cl. CPC H04L 63/0435; G06F 12/1408; G06F 2212/402; H04L 9/0866; G06F 21/602; H04L 63/0876

(57) ABSTRACT

A method for offline playback of multimedia files includes receiving an encrypted multimedia file and an encrypted file key from a server. The encrypted multimedia file is transmitted to a communication device in a vehicle based on a selection input by a control device. A request is received for a file key from the communication device. The encrypted file key is decrypted by using a device key to generate the file key. The file key is transmitted to the communication device for the offline playback of the multimedia file.

### CROSS-RELATED APPLICATIONS

This application claims priority of Indian Non-Provisional Application No. 201741002271, filed Dec. 29, 2017, which claims the benefit of Indian Provisional Application No. 201741002271, filed Jan. 20, 2017, the contents of which are incorporated herein by reference.

### FIELD OF THE INVENTION

The present invention relates generally to playback of multimedia files, and more particularly to a method and system for offline playback of multimedia files protected with digital rights management (DRM) scheme.

### BACKGROUND

Various DRM schemes are utilized worldwide to manage content for authenticated users. The content includes various multimedia files of movies, television shows, e-books, songs, audiobooks, and the like. Several content service providers that implement DRM schemes include a DRM content server and a DRM license server. The DRM content server stores and provides the content to an authenticated user whereas the DRM license server provides a license using which the user can view or listen to the content by way of a communication device.

To play a multimedia file that is protected under the DRM scheme, an active internet connection is required between the communication device, the DRM content server, and the DRM license server. The DRM content server transmits the content in an encrypted format to the communication device. For playback of the content, the communication device has to decrypt the encrypted content. Therefore, the communication device transmits a DRM certificate to the DRM license server through the internet connection. In one embodiment, the DRM certificate includes a public key of the communication device. The DRM license server checks the DRM certificate and authenticates the communication device based on the DRM certificate. Further, the DRM license server transmits an encrypted file key to the user device, where the DRM license server encrypts the file key with the public key of the communication device. The communication device receives the encrypted file key over the internet and decrypts the encrypted file key using its private key. Further, the communication device decrypts the encrypted content and starts playback of the content. Thus, the communication device requires an uninterrupted internet connection for playing the content on the communication device. In one scenario, the communication device is an in-vehicle entertainment system installed in a vehicle. The vehicle may be in motion and therefore, the probability of the in-vehicle entertainment system losing internet connectivity is very high. This not only ceases the transmission of the content from the DRM content server but also prevents the in-vehicle entertainment system to retrieve the encrypted file key from the DRM license server. Hence, the playback of the content is disrupted.

Therefore, it would be advantageous to have an in-vehicle entertainment system that allows the playback of the content that is protected with the DRM scheme even when the network connectivity is lost to give the user a pleasant and enjoyable travel experience.

### SUMMARY

In an embodiment of the present invention, a method for offline playback of multimedia files is provided. The method includes receiving, by a first control device in a first vehicle, at least an encrypted first multimedia file and an encrypted first file key from a server over a first communication network. The server encrypts a first multimedia file by using a first file key to generate the encrypted first multimedia file. Further, the server encrypts the first file key by using a first device key associated with the first control device to generate the encrypted first file key. The encrypted first multimedia file is transmitted to a communication device in the first vehicle based on a selection input by the first control device. A request for the first file key is received by the first control device from the communication device. The first control device decrypts the encrypted first file key by using the first device key to generate the first file key. The first file key is transmitted to the communication device by the first control device. The communication device decrypts the encrypted first multimedia file by using the first file key for the offline playback of the first multimedia file.

In an embodiment of the present invention, a system for offline playback of multimedia files is provided. The system includes a first control device that further includes a memory and a processor. The memory is configured to store at least an encrypted first multimedia file, an encrypted first file key, and a first device key associated with the first control device. The processor is configured to receive at least the encrypted first multimedia file and the encrypted first file key from a server over a first communication network. The server encrypts a first multimedia file by using a first file key to generate the encrypted first multimedia file. Further, the server encrypts the first file key by using the first device key to generate the encrypted first file key. The processor is further configured to transmit the encrypted first multimedia file to a communication device in the first vehicle based on a selection input. The processor is further configured to receive a request for the first file key from the communication device. The processor further decrypts the encrypted first file key by using the first device key to generate the first file key. The processor is further configured to transmit the first file key to the communication device. The communication device further decrypts the encrypted first multimedia file by using the first file key for the offline playback of the first multimedia file.

Various embodiments of the present invention provide a method and system for offline playback of multimedia files protected with DRM scheme. A server receives the multimedia files from a content provider and further encrypts each multimedia file by using a corresponding file key. The server stores device keys associated with control devices of multiple vehicles. To provide an encrypted first multimedia file to a first control device of a first vehicle, the server encrypts a first file key, used to encrypt the first multimedia file, by using a first device key of the first control device. The server then transmits the encrypted first multimedia file and the encrypted first file key to the first control device, and the first control device stores the encrypted first multimedia file and the encrypted first file key. When a passenger boards the first vehicle and requests to view the first multimedia file by providing a first input, the first control device transmits the encrypted first multimedia file to a first communication device in the first vehicle. The first communication device requests the first file key from the first control device to start the offline playback of the first multimedia file. The first control device receives the request, and retrieves the encrypted first file key and the first device key from its memory. Further, the first control device decrypts the encrypted first file key by using the first device key and transmits the first file key to the first communication device. The first communication device receives the first file key and decrypts the encrypted first multimedia file for the offline playback, thereby presenting the first multimedia file to the passenger. Since the first communication device requests the first control device for the first file key, an active internet connection is not required for the playback of the first multimedia file. Therefore, the system enables the offline playback of multimedia files in an automotive environment.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements:

FIG. 1 is a block diagram that illustrates a system environment for providing offline playback of multimedia files, in accordance with an embodiment of the present invention;

FIG. 2 illustrates a control device and a communication device in a vehicle of the system environment of FIG. 1, in accordance with an embodiment of the present invention;

FIGS. 3A, 3B, and 3C, collectively, represent a flow chart that illustrates a method to provide an offline playback of multimedia files in the system environment of FIG. 1, in accordance with an embodiment of the present invention; and

FIG. 4 is a block diagram that illustrates a computer system for providing offline playback of multimedia files, in accordance with an embodiment of the present invention.

Further areas of applicability of the present invention will become apparent from the detailed description provided hereinafter. It should be understood that the detailed description of exemplary embodiments are intended for illustration purposes only and are, therefore, not intended to necessarily limit the scope of the invention.

### DETAILED DESCRIPTION

As used in the specification and claims, the singular forms “a”, “an” and “the” may also include plural references. In an example, the term “an article” may include a plurality of articles. Those with ordinary skill in the art will appreciate that the elements in the Figures are illustrated for simplicity and clarity and are not necessarily drawn to scale. In an example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes a system for offline playback of multimedia files. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “at least one embodiment”, “another embodiment”, “one example”, “an example”, “another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

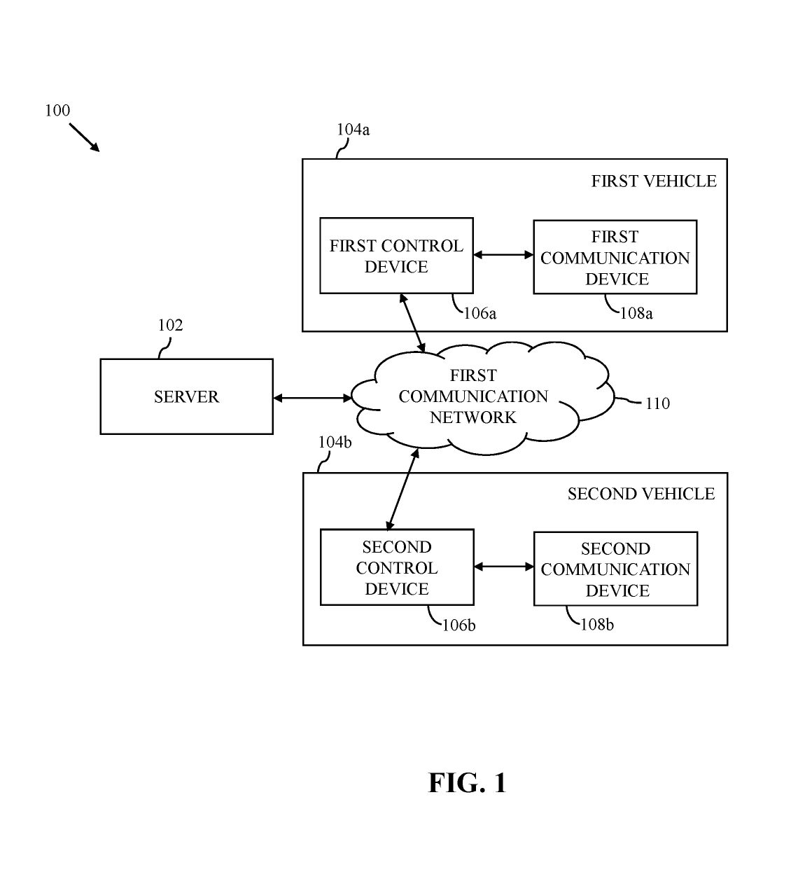

Referring to FIG. 1, a block diagram that illustrates a system environment 100 for providing offline playback of multimedia files, in accordance with an embodiment of the present invention is shown. The system environment 100 includes a server 102. In one embodiment, the system environment 100 is an automotive environment that includes first and second vehicles 104a and 104b. The first vehicle 104a includes a first control device 106a and a first communication device 108a. Further, the second vehicle 104b includes a second control device 106b and a second communication device 108b. The first control device 106a and the second control device 106b communicate with the server 102 by way of a first communication network 110.

The server 102 is a content management server that manages entertainment content, such as multimedia files of various movies, television shows, songs, audiobooks, and the like. Thus, a first multimedia file may correspond to a movie and a second multimedia file may correspond to a television show. In one embodiment, the server 102 further categorizes the multimedia files into one or more categories based on one or more properties of the multimedia files. The one or more properties may include language, genre, and the like. The multimedia files are protected with a digital rights management (DRM) scheme. Thus, the server 102 encrypts the first multimedia file by using a first file key and the second multimedia file by using a second file key. The server 102 stores an encrypted format of the multimedia files, i.e., an encrypted format of the first and second multimedia files, hereinafter “the encrypted first multimedia file” and “the encrypted second multimedia file”, and the corresponding first and second file keys in a memory (not shown).

The server 102 further stores various device keys associated with control devices in various vehicles. In one example, the server 102 stores a first device key associated with the first control device 106a of the first vehicle 104a and a second device key associated with the second control device 106b of the second vehicle 104b. The server 102 provides the multimedia files to the first and second vehicles 104a and 104b for the passengers (not shown) riding in the first and second vehicles 104a and 104b. The server 102 further ensures that the multimedia files provided to the first and second vehicles 104a and 104b are protected with the DRM scheme by using the first and second device keys, respectively. The server 102 further stores profiles of passengers, hereinafter “passenger profiles”, who avail the first and second vehicles 104a and 104b for travelling from one location to another at different point in time. In an example, a first passenger rides in the first vehicle 104a on Apr. 24, 2017 and rides in the second vehicle 104b on May 5, 2017.

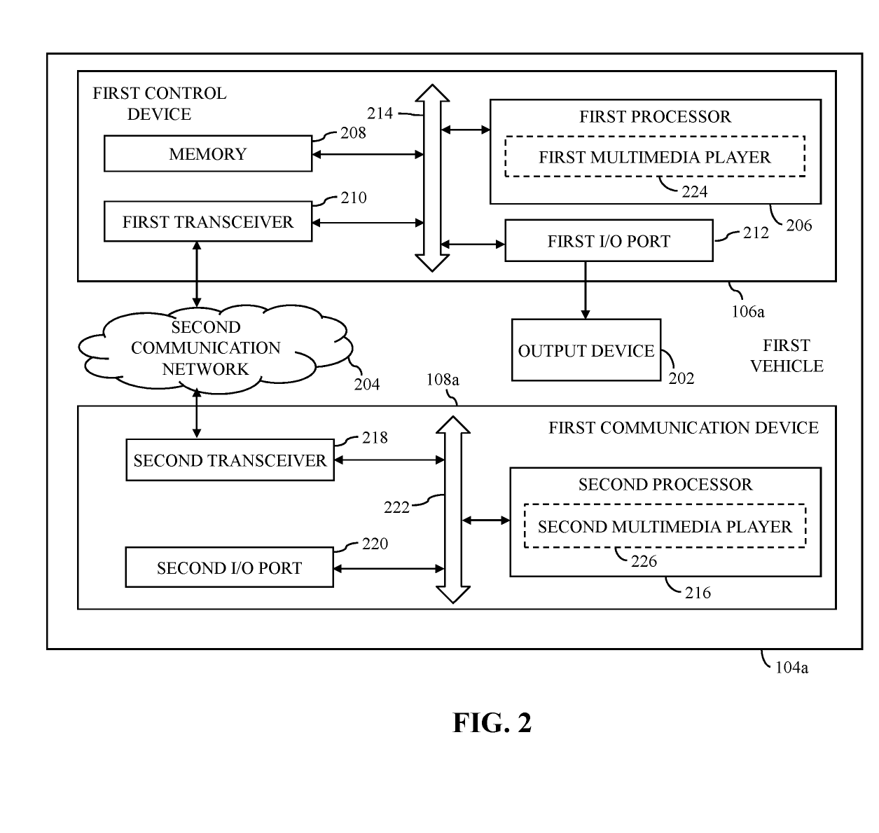

A passenger profile of the first passenger may include personal details such as name, age, gender, address, travel history, viewed content history, travel preferences, and the like. The travel history of the first passenger includes a travel summary of various trips that the first passenger has made in past on the first and second vehicles 104a and 104b. The viewed content history of the first passenger includes a summary of the multimedia files viewed by the first passenger in the past while travelling in the first and second vehicles 104a and 104b. The server 102 further updates the passenger profile of the first passenger based on the trips of the first passenger in the first and second vehicles 104a and 104b. Examples of the server 102 include, but are not limited to, a personal computer, a laptop, or a network of computer systems. The functionality of the server 102 for providing the multimedia files to the first and second vehicles 104a and 104b is explained in FIG. 2.

The first vehicle 104a corresponds to a means of transport that is deployed by a vehicle service provider, such as a taxicab provider, to provide ride services to passengers. Examples of the first vehicle 104a may include a car, a bus and the like. Passengers may travel in the first vehicle 104a to commute from a source location to a destination location. Various methods of providing vehicle services to passengers used by the vehicle service provider will be apparent to a person skilled in the relevant art.

The first control device 106a is a computing device that is installed in the first vehicle 104a. In one embodiment, the first control device 106a is a vehicle head unit of the first vehicle 104a that controls an in-vehicle entertainment media, such as radio, compact disc (CD) drives, multimedia players, global positioning system (GPS) navigation, Bluetooth, and the like, of the first vehicle 104a. The first control device 106a further receives the multimedia files that are protected with the DRM scheme from the server 102, over the first communication network 110. In an embodiment, the first control device 106a receives the encrypted first and second multimedia files, and first and second file keys in an encrypted format, hereinafter “encrypted first key” and “encrypted second key”, from the server 102. The first control device 106a is associated with a unique identification number. In one example, the unique identification number is an international mobile equipment identity (IMEI) number. In the example, the IMEI number of the first control device 106a is the first device key associated with the first control device 106a. In another example, the unique identification number includes a unique device identifier (UDID), a unique device name, a unique device number, and the like. The first control device 106a communicates with the first communication device 108a for providing offline playback of the first and second multimedia files.

The first communication device 108a is a computing device installed in the first vehicle 104a using which a passenger travelling in the first vehicle 104a views the first and second multimedia files. In one embodiment, the first communication device 108a is offline. For the playback of the first multimedia file, the first communication device 108a receives the encrypted first multimedia file from the first control device 106a and further decrypts the encrypted first multimedia file with the first file key received from the first control device 106a. The first communication device 108a plays the first multimedia file through a display screen. Examples of the first communication device 108a include, but are not limited to, a smartphone, a personal digital assistant (PDA), a tablet, or any other portable communication device.

The second vehicle 104b corresponds to a means of transport that is deployed by the vehicle service provider, such as a taxicab provider, to provide ride services to the passengers. Examples of the second vehicle 104b may include a car, a bus and the like. It will be apparent to a person skilled in the relevant art that the second control device 106b and the second communication device 108b are functionally similar to the first control device 106a and the first communication device 108a, respectively. The second control device 106b is associated with the second device key. In one embodiment, the second device key is the IMEI number of the second control device 106b. It will be further apparent to a person skilled in the art that the first and second vehicles 104a and 104b may be train, airplane, and the like.

The first communication network 110 corresponds to a medium through which the server 102 transmits the multimedia files to the first and second control devices 106a and 106b. Examples of the first communication network 110 include, but are not limited to, a wireless fidelity (Wi-Fi) network, a light fidelity (Li-Fi) network, a satellite network, an internet, a mobile network (e.g., cellular data, high speed packet access (HSPA)), or any combination thereof. Various devices in the system environment 100 may connect to the first communication network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G) communication protocols, or any combination thereof.

Referring now to FIG. 2, the first control device 106a and the first communication device 108a of the first vehicle 104a in accordance with an embodiment of the present invention are shown. The first vehicle 104a further includes an output device 202. The first control device 106a communicates with the first communication device 108a by way of a second communication network 204. Examples of the second communication network 204 include, but are not limited to, a Wi-Fi network, a Li-Fi network, a fiber optic network, a coaxial cable network, an infrared network, a radio frequency (RF) network, or any combination thereof. Various devices in the first vehicle 104a may connect to the second communication network 204 in accordance with various wired and wireless communication protocols, such as TCP/IP, UDP, 2G, 3G, 4G communication protocols, or any combination thereof.

The first control device 106a includes a first processor 206, a memory 208, a first transceiver 210, and a first input/output (I/O) port 212 that communicate with each other by way of a first bus 214. Further, the first communication device 108a includes a second processor 216, a second transceiver 218, and a second I/O port 220 that communicate with each other by way of a second bus 222.

The output device 202 is installed in the first vehicle 104a. In one embodiment, the output device 202 is an audio output device, such as speakers, headphones, embedded in the first vehicle 104a to output audio data. In one example, the audio data is an audio component of the first multimedia file that is outputted during a playback of the first multimedia file. In another example, the audio data is an audio message for navigation guidance.

The first processor 206 includes suitable logic, circuitry, and/or interfaces to execute instructions stored in the memory 208. The first processor 206 receives the encrypted first and second multimedia files, and the encrypted first file key from the server 102 by way of the first transceiver 210. The first processor 206 further transmits the encrypted first and second multimedia files to the first communication device 108a by way of the first transceiver 210. The first processor 206 further decrypts the encrypted first file key and transmits the first file key to the first communication device 108a by way of the first transceiver 210. Examples of the first processor 206 include an application-specific integrated circuit (ASIC) processor, a reduced instruction set computing (RISC) processor, a complex instruction set computing (CISC) processor, and the like. It will be apparent to a person skilled in the art that the first processor 206 is compatible with multiple operating systems. The first processor 206 plays an audio component of the first multimedia file through the output device 202 by way of a first multimedia player 224. Examples of the first multimedia player 224 include Quicktime® player, Windows® Media Player, Video LAN client (VLC®) media player, RealPlayer®, iTunes®, and the like.

The first transceiver 210 includes suitable logic, circuitry, and/or interfaces to transmit or receive messages from various devices, such as the server 102 and the second transceiver 218. The first transceiver 210 communicates with the server 102 through the first communication network 110 and the second transceiver 218 through the second communication network 204. The first transceiver 210 receives the encrypted first and second multimedia files, and the encrypted first and second file keys from the server 102. Further, the first transceiver 210 transmits the encrypted first multimedia file and the first file key to the second transceiver 218 for playback of the first multimedia file. Examples of the first transceiver 210 include, but are not limited to, an antenna, a radio frequency transceiver, a wireless transceiver, a Bluetooth transceiver, and the like. The first transceiver 210 communicates with the server 102, the first processor 206, and the second transceiver 218 using various wired and wireless communication protocols, such as TCP/IP, UDP, 2G, 3G, 4G communication protocols, or any combination thereof.

The memory 208 includes suitable logic, circuitry, and/or interfaces to store the encrypted first and second multimedia files, the encrypted first and second file keys, and the first device key. The memory 208 further stores a decryption algorithm for decrypting the encrypted first and second file keys. Examples of the memory 208 include, but are not limited to, a random access memory (RAM), a read-only memory (ROM), a programmable ROM (PROM), an erasable PROM (EPROM), and the like.

The first I/O port 212 includes suitable logic, circuitry, and/or interfaces that connect the first control device 106a to various input and output devices, such as the output device 202, of the first vehicle 104a. Examples of the first I/O port 212 include a universal serial bus (USB) port, an Ethernet port, and the like.

The second processor 216 includes suitable logic, circuitry, and/or interfaces to provide an offline playback of the multimedia files that a passenger travelling in the first vehicle 104a requests. In an example, a passenger provides a first input for selecting a first identifier that corresponds to the first multimedia file. The second processor 216 transmits the first input, i.e., a selection input, pertaining to the first multimedia file to the first control device 106a by way of the second transceiver 218 and the second communication network 204. Further, the second processor 216 receives the encrypted first multimedia file and the first file key from the first control device 106a, and decrypts the encrypted first multimedia file by using the first file key and a decryption algorithm. The decryption algorithm may be stored in a memory (not shown) of the first communication device 108a. Examples of the second processor 216 include an ASIC processor, a RISC processor, a CISC processor, and the like. It will be apparent to a person skilled in the art that the second processor 216 is compatible with multiple operating systems. The second processor 216 further plays the first multimedia file by way of a second multimedia player 226. Examples of the second multimedia player 226 include Quicktime® player, Windows® Media Player, VLC® media player, RealPlayer®, iTunes®, and the like.

The second transceiver 218 includes suitable logic, circuitry, and/or interfaces to transmit or receive messages from various devices, such as the first transceiver 210. The second transceiver 218 communicates with the first transceiver 210 through the second communication network 204. The second transceiver 218 transmits the first input, i.e., the selection input, provided by the passenger to the first control device 106a. The second transceiver 218 further receives the encrypted first multimedia file and the first file key from the first control device 106a. Examples of the second transceiver 218 include, but are not limited to, an antenna, a radio frequency transceiver, a wireless transceiver, a Bluetooth transceiver, and the like. The second transceiver 218 communicates with the first transceiver 210 and the second processor 216 using various wired and wireless communication protocols, such as TCP/IP, UDP, 2G, 3G, 4G communication protocols, or any combination thereof.

The second I/O port 220 includes suitable logic, circuitry, and/or interfaces that provides an output to the passenger and further enables the passenger to provide an input for the playback of various multimedia files. The second I/O port 220 may include output devices, such as a display screen, a speaker, headphones, and the like. Further, the second I/O port 220 may include input devices, such as a touchscreen, a keyboard, a mouse, a joystick, a microphone, and the like.

In operation, the server 102 receives the first and second multimedia files, i.e., entertainment content, from a content provider server (not shown) over the first communication network 110. The server 102 encrypts the first and second multimedia files by using the first and second file keys, respectively. In one example, the server 102 encrypts a first multimedia file “M1” by using a first file key “K1” and a second multimedia file “M2” by using a second file key “K2”. The first file key “K1” is different from the second file key “K2”. Alternatively stated, the server 102 encrypts each multimedia file by using a unique file key. For the encryption of the first and second multimedia files, the server 102 uses one or more encryption algorithms known in the relevant art.

The server 102 stores the encrypted first and second multimedia files, and the corresponding first and second file keys in a catalogue table that is stored in a memory (not shown). The server 102 further updates the catalogue table to store a new encrypted multimedia file and its corresponding file key. The server 102 further stores the first and second device keys of the first and second control devices 106a and 106b, respectively, in the memory (not shown).

In order to provide the encrypted first multimedia file to the first control device 106a, the server 102 retrieves the first file key and the first device key associated with the first control device 106a of the first vehicle 104a. Further, the server 102 encrypts the first file key by using the first device key and generates the encrypted first file key. For the encryption of the first file key, the server 102 uses one or more encryption algorithms known in the relevant art. The server 102 further transmits the encrypted first multimedia file and the encrypted first file key to the first control device 106a, over the first communication network 110. The first processor 206 receives the encrypted first multimedia file and the encrypted first file key from the server 102 by way of the first transceiver 210. Further, the first processor 206 stores the encrypted first multimedia file and the encrypted first file key in the memory 208. The memory 208 further stores the first device key of the first control device 106a.

The first transceiver 210 generates a communication channel to communicate with the second transceiver 218 through the second communication network 204, when a passenger rides in the first vehicle 104a. Further, the first processor 206 transmits a set of identifiers associated with a corresponding set of encrypted multimedia files stored in the memory 208 to the second transceiver 218. In one example, the set of identifiers includes a first identifier associated with the encrypted first multimedia file. In one embodiment, the first identifier is a title “M1” of the first multimedia file.

The second transceiver 218 receives the set of identifiers. Further, the second processor 216 renders the set of identifiers through the second I/O port 220 for the passenger travelling in the first vehicle 104a. The passenger provides the first input to select one identifier of the set of identifiers. In one example, the passenger selects a first identifier. In one embodiment, the passenger selects the first identifier by pressing a physical key on the second I/O port 220. In another embodiment, the passenger selects the first identifier by pressing a virtual key on the second I/O port 220. In yet another embodiment, the passenger selects the first identifier by directly clicking on the first identifier rendered through a Graphical User Interface (GUI). It will be apparent to a person skilled in the art that the passenger may also use any other means known in the art for providing the first input. The second transceiver 218 further transmits the first input pertaining to the selection of the first identifier to the first transceiver 210 through the communication channel.

The first transceiver 210 receives the first input. Based on the first input pertaining to the first identifier, the first processor 206 determines that the passenger wants to view the first multimedia file. Therefore, the first processor 206 transmits the encrypted first multimedia file to the second transceiver 218 by way of the first transceiver 210. In one example, the first transceiver 210 streams the encrypted first multimedia file to the second transceiver 218 through the communication channel.

The second transceiver 218 receives the encrypted first multimedia file. The second processor 216 initiates a playback of the encrypted first multimedia file by using the second multimedia player 226. In order to play the encrypted first multimedia file, the second multimedia player 226 requires the first file key. Thus, the second processor 216 in conjunction with the second multimedia player 226 generates a request for the first file key. The second processor 216 in conjunction with the second multimedia player 226 transmits the request for the first file key to the first transceiver 210 by way of the second transceiver 218 and the second communication network 204.

The first transceiver 210 receives the request for the first file key and communicates the request for the first file key to the first processor 206. Based on the request for the first file key, the first processor 206 retrieves the encrypted first file key and the first device key from the memory 208. Further, the first processor 206 decrypts the encrypted first file key by using the first device key in real time or near real time. Alternatively stated, the first processor 206 decrypts the encrypted first file key on-the-fly. For the decryption of the encrypted first file key, the first processor 206 uses a decryption algorithm stored in the memory 208. The decryption algorithm may be compatible with the encryption algorithm used by the server 102 to encrypt the first file key using the first device key. The first processor 206 transmits the first file key to the second transceiver 218 through the communication channel.

The second transceiver 218 receives the first file key. The second processor 216 provides the first file key to the second multimedia player 226. Further, the second processor 216 in conjunction with the second multimedia player 226 decrypts the encrypted first multimedia file and starts the offline playback of the first multimedia file through the second I/O port 220. The second processor 216 further controls the playback of the first multimedia file through the second multimedia player 226. The second processor 216 thus renders a video component of the first multimedia file through the second I/O port 220 and the first processor 206 renders an audio component of the first multimedia file through the output device 202. It will be apparent to a person skilled in the art that in another embodiment the second I/O port 220 may be configured to render the audio component.

In one embodiment, the encrypted first multimedia file may have multiple encrypted segments. Thus, the second processor 216 transmits a request for the first file corresponding to each segment and the first processor 206 transmits the first file key in response to each request.

In one embodiment, the server 102 further transmits information pertaining to a third multimedia file viewed by the passenger in a previous ride to the first control device 106a. The passenger may have previously travelled in the first or second vehicle 104a or 104b, or a vehicle other than the first and second vehicles 104a and 104b. The information includes a timestamp associated with the third multimedia file at which the passenger either paused or stopped viewing the third multimedia file in his or her previous ride. An encrypted third multimedia file and a corresponding third encrypted file key may be stored in the memory 208. Thus, the first processor 206 transmits an identifier associated with the encrypted third multimedia file to the second processor 216. When the passenger selects the identifier associated with the encrypted third multimedia file, the playback of the third multimedia file may resume from the timestamp at which it was either paused or stopped in his or her previous ride. In one embodiment, the first communication device 108a is a user device of the passenger travelling in the first vehicle 104a. Further, the passenger may control the playback of the first multimedia file through the second multimedia player 226.

It will be apparent to a person skilled in the art that the first control device 106a may store multiple encrypted media files and corresponding encrypted file keys. Further, the second control device 106b and the second communication device 108b of the second vehicle 104b execute the offline playback of multimedia files in a similar way as executed by the first control device 106a and the first communication device 108a of the first vehicle 104a. In one embodiment, the server 102 may provide the multimedia files to the first and second control devices 106a and 106b based on the one or more categories. In one example, the server 102 may provide the encrypted first multimedia file associated with a “comic” category to the first control device 106a and the encrypted second multimedia file associated with a “drama” category to the second control device 106b.

Thus, the system environment 100 provides a mechanism for offline playback of multimedia files that are protected with the DRM schemes. The multimedia files and corresponding file keys are stored in an encrypted format in the first and second control devices 106a and 106b of the first and second vehicles 104a and 104b. Since, file keys of the encrypted multimedia files are further encrypted by using a device key that is unique for each of the first and second control devices 106a and 106b, the likelihood of unauthorized use of the multimedia files is prevented. In one example, an unauthorized user may copy the encrypted first multimedia file and the encrypted first file key from the memory 208 of the first control device 106a to his or her personal computing device (not shown). However, the unauthorized user may not be able to playback the first multimedia file as the encrypted first file key may only be decrypted by using the first device key of the first control device 106a and not a device key of the personal computing device.

The encrypted first multimedia file and the encrypted first file key are stored in the memory 208 of the first control device 106a. Thus, the second multimedia player 226 sends an offline request for the first file key to the first control device 106a instead of a DRM license server, which would require an active internet connection. Hence, the system environment 100 overcomes a need for online connection for the playback of the first multimedia file that would have disrupted a passenger's experience of viewing the multimedia files in an event of a poor internet connection. Therefore, the system environment 100 provides a joyful and pleasant content viewing experience to the passenger without having any online connectivity and unauthorized access to the entertainment content.

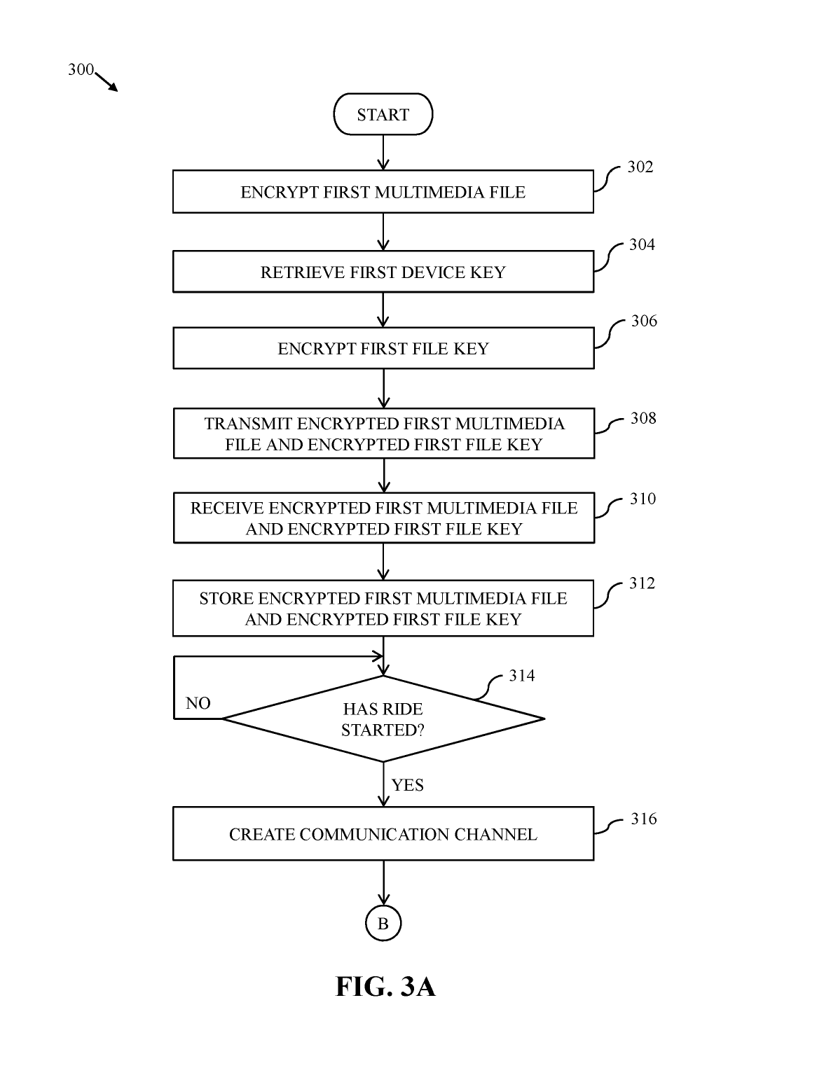

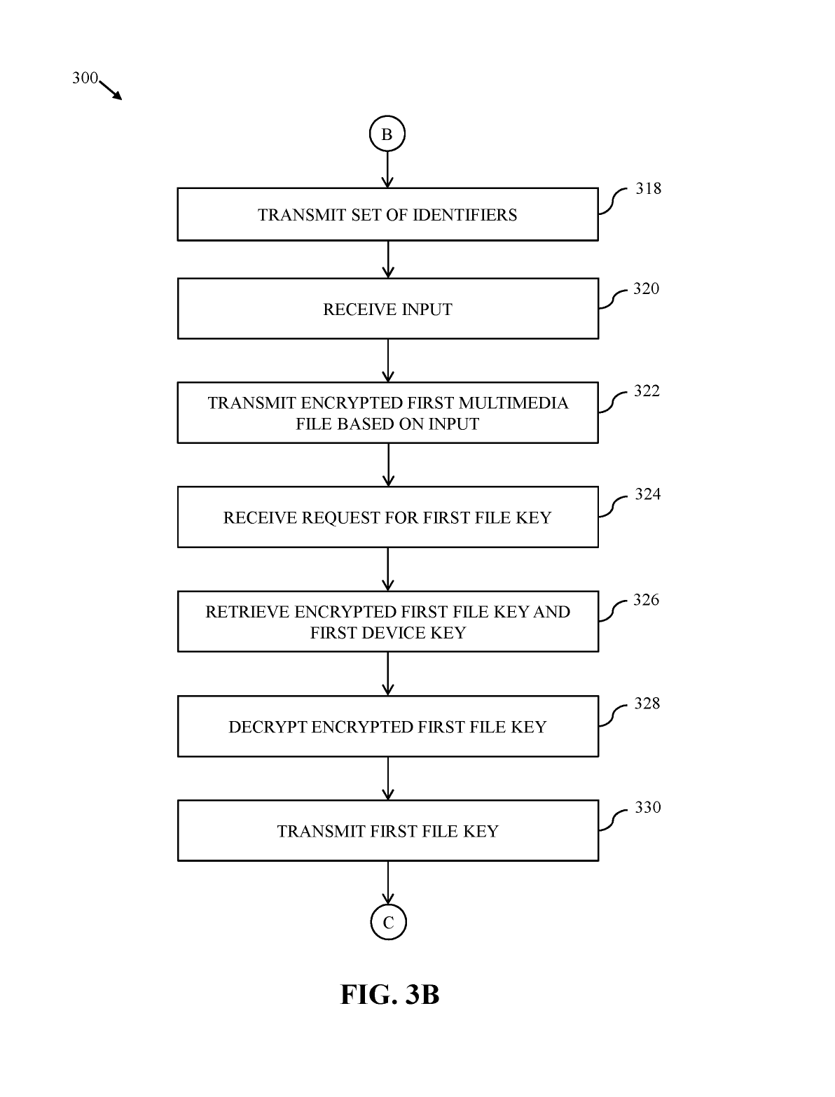

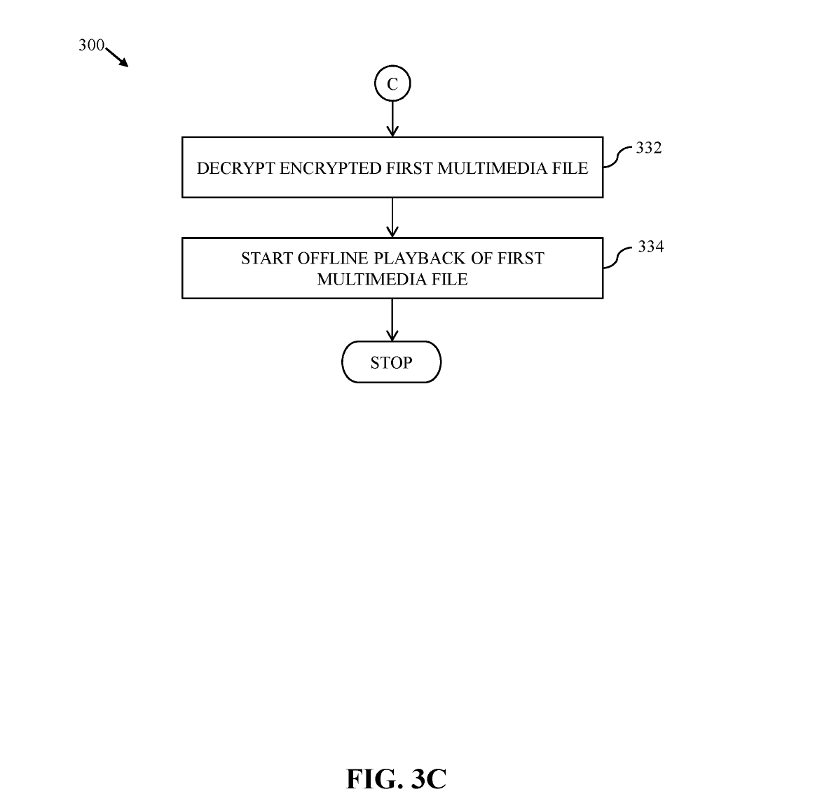

Referring now to FIGS. 3A, 3B, and 3C, a flow chart 300 that illustrates a method to provide an offline playback of multimedia files using the system environment 100 in accordance with an embodiment of the present invention is shown.

At step 302, the server 102 encrypts the first multimedia file to generate the encrypted first multimedia file by using the first file key. The server 102 stores the encrypted first multimedia file and the first file key in its memory. At step 304, the server 102 retrieves the first device key of the first control device 106a from the memory (not shown) for proving content protected with the DRM scheme to the first control device 106a.

At step 306, the server 102 encrypts the first file key to generate the encrypted first file key by using the first device key. At step 308, the server 102 transmits the encrypted first multimedia file and the encrypted first file key to the first control device 106a, through the first communication network 110. It will be apparent to a person skilled in the art that the server 102 transmits a set of encrypted multimedia files and a set of encrypted first file keys to the first control device 106a. At step 310, the first transceiver 210 receives the encrypted first multimedia file and the encrypted first file key. At step 312, the first processor 206 stores the encrypted first multimedia file and the encrypted first file key in the memory 208.

At step 314, the first processor 206 determines whether the ride has started. Alternatively stated, the first processor 206 determines whether the passenger has boarded the first vehicle 104a for the ride. If at step 314, it is determined that the ride has not started, the first processor 206 waits for the passenger to board the first vehicle 104a and the ride to start. However, if at step 314, it is determined that the ride has started, step 316 is performed. At step 316, the first transceiver 210 creates the communication channel to communicate with the second transceiver 218 by way of the second communication network 204.

At step 318, the first processor 206 transmits a set of identifiers to the second processor 216 by way of the first and second transceivers 210 and 218, and the second communication network 204. At step 320, the first processor 206 receives the first input from the second processor 216. The passenger travelling in the first vehicle 104a provides the first input by selecting the first identifier. At step 322, the first processor 206 transmits the encrypted first multimedia file to the second processor 216 based on the first input by way of the second communication network 204.

At step 324, the first processor 206 receives a request for the first file key from the second processor 216. The second processor 216 in conjunction with the second multimedia player 226 transmits the request for the first file key for playback of the first multimedia file. At step 326, the first processor 206 retrieves the encrypted first file key from the memory 208. The first processor 206 further retrieves the first device key from the memory 208.

At step 328, the first processor 206 decrypts the encrypted first file key by using the first device key to generate the first file key. At step 330, the first processor 206 transmits the first file key to the second processor 216 by way of the second communication network 204. At step 332, the second processor 216 decrypts the encrypted first multimedia file by using the first file key. At step 334, the second processor 216 starts the offline playback of the first multimedia file by using the second multimedia player 226. The second processor 216 further controls the offline playback of the first multimedia file through the second multimedia player 226.

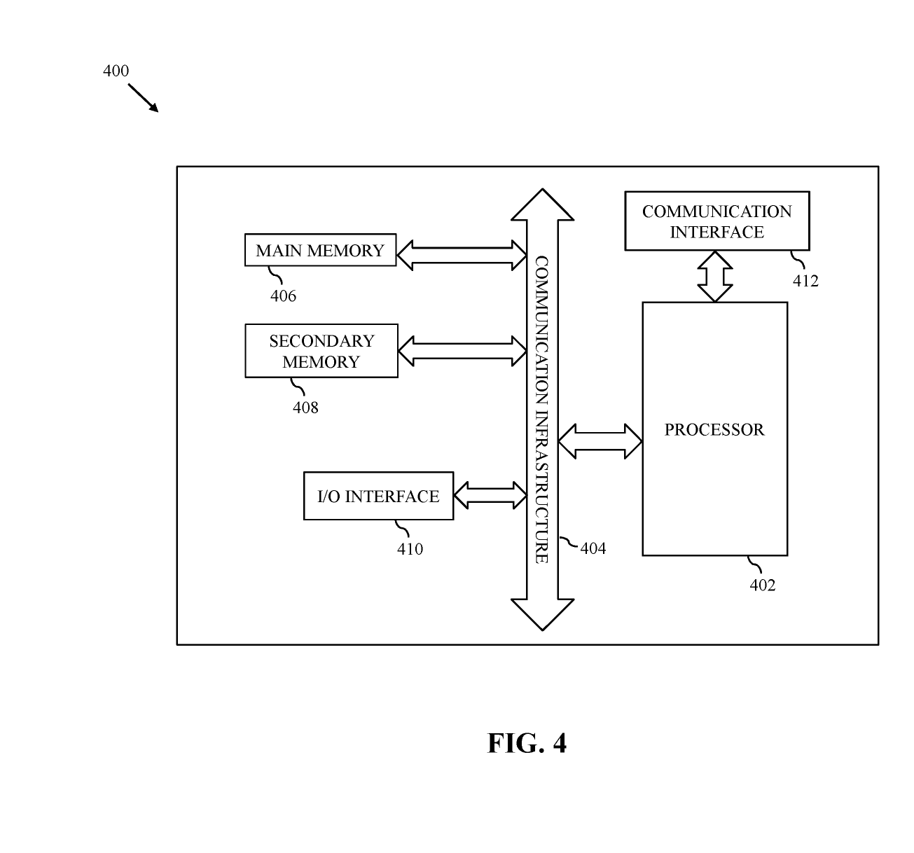

FIG. 4 is a block diagram that illustrates a computer system 400 for providing offline playback of multimedia files, in accordance with an embodiment of the present invention. An embodiment of present invention, or portions thereof, may be implemented as computer readable code on the computer system 400. In one example, the server 102, the first control device 106a, the first communication device 108a, the second control device 106b, and the second communication device 108b of FIG. 1 may be implemented in the computer system 400. Further, the computer system 400 may be realized in the form of a personal computer, a laptop, a server, a tablet, a PDA, a cellular telephone, a server, or any machine that is capable of executing a set of computer instructions that are to be executed by the computer system 400.

The computer system 400 includes a processor 402 that may be a special purpose or a general purpose processing device. The processor 402 may correspond to a single processor, a plurality of processors, or combinations thereof. The processor 402 may have one or more processor “cores.” Further, the processor 402 may be connected to a communication infrastructure 404, such as a bus, i.e., the first bus 214 and the second bus 222, a bridge, a message queue, a network, i.e., the first communication network 110 or the second communication network 204, multi-core message-passing scheme, and the like. The computer system 400 further includes a main memory 406 and a secondary memory 408. Examples of the main memory 406 may include RAM, ROM, PROM, EPROM, and the like. The secondary memory 408 may include a hard disk drive or a removable storage drive, such as a floppy disk drive, a magnetic tape drive, an optical disk drive, a flash memory, and the like. Further, the removable storage drive may read from and/or write to a removable storage device in a well-known manner. In one embodiment, the removable storage device may be a non-transitory computer readable recording media.

The computer system 400 further includes an input/output (I/O) interface 410 and a communication interface 412. The I/O interface 410 includes various input and output devices that are configured to communicate with the processor 402. Examples of the input devices may include a keyboard, a mouse, a joystick, a touchscreen, a microphone, and the like. Examples of the output devices may include a display screen, a speaker, headphones, and the like. The communication interface 412 may allow data to be transferred between the computer system 400 and various external devices. Exemplary communication interfaces 412 may include a modem, a network interface, i.e., an Ethernet card, a communications port, and the like. Data transferred via the communication interface 412 may be in the form of signals, which may be electronic, electromagnetic, optical, or other signals as will be apparent to persons having skill in the relevant art. The signals may travel via a communication channel (not shown) which may be configured to carry the signals and may be implemented using wire, cable, fiber optics, a phone line, a cellular phone link, a radio frequency link, and the like.

Computer program medium and computer usable medium may refer to memories, such as the main memory 406 and the secondary memory 408, which may be memory semiconductors, such as dynamic RAMs. These computer program products may be means for providing data to the computer system 400 that enable computer system 400 to implement the methods illustrated by FIGS. 3A-3C, as discussed herein. In one embodiment, the present invention is implemented using a computer implemented application, the computer implemented application may be stored in a computer program product and loaded into the computer system 400 using the removable storage drive or the hard disc drive in the secondary memory 408, the I/O interface 410, or the communication interface 412.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 402 and a memory such as the main memory 406 and the secondary memory 408 may be used to implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without deviating from the scope of present invention.

Techniques consistent with the present invention provide, among other features, systems and methods for offline playback of multimedia files. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

1. A method for offline playback of multimedia files, the method comprising:
receiving, by a first control device in a first vehicle, at least an encrypted first multimedia file and an encrypted first file key from a server over a first communication network, wherein the server encrypts a first multimedia file by using a first file key to generate the encrypted first multimedia file, and wherein the server encrypts the first file key by using a first device key associated with the first control device to generate the encrypted first file key;
transmitting, by the first control device in the first vehicle, the encrypted first multimedia file to a communication device in the first vehicle based on a selection input;
receiving, by the first control device in the first vehicle, a request for the first file key from the communication device; and
transmitting, by the first control device in the first vehicle, the first file key to the communication device, wherein the first control device decrypts the encrypted first file key by using the first device key to generate the first file key, and wherein the communication device decrypts the encrypted first multimedia file by using the first file key for the offline playback of the first multimedia file.

2. The method of claim 1, further comprising:
storing, by the first control device, a plurality of encrypted multimedia files and a plurality of encrypted file keys, wherein the plurality of encrypted multimedia files include the encrypted first multimedia file and the plurality of encrypted file keys include the encrypted first file key.

3. The method of claim 1, wherein the first control device transmits the encrypted first multimedia file to the communication device through a second communication network, when a passenger rides the first vehicle.

4. The method of claim 1, wherein the first device key associated with the first control device in the first vehicle is different from a second device key of a second control device in a second vehicle.

5. The method of claim 1, further comprising:
transmitting, by the first control device in the first vehicle, a first identifier associated with the first multimedia file to the communication device.

6. The method of claim 5, further comprising:
receiving, by the first control device in the first vehicle, the selection input of the first multimedia file from the communication device based on the first identifier.

7. The method of claim 1, further comprising:
decrypting, by the first control device in the first vehicle, the encrypted first file key to generate the first file key in real time.

8. The method of claim 1, wherein the communication device is offline, wherein the communication device plays the first multimedia file by way of a multimedia player, and wherein the multimedia player transmits the request to the first control device for the first file key for the offline playback of the first multimedia file.

9. The method of claim 1, wherein the server encrypts a second multimedia file by using a second file key, and wherein the first file key is different from the second file key.

10. A system for offline playback of multimedia files, the system comprising:
a first control device in a first vehicle, the first control device comprising:
a memory configured to store at least an encrypted first multimedia file, an encrypted first file key, and a first device key associated with the first control device; and
a processor that communicates with the memory, wherein the processor is configured to:
receive at least the encrypted first multimedia file and the encrypted first file key from a server over a first communication network, wherein the server encrypts a first multimedia file by using a first file key to generate the encrypted first multimedia file, and wherein the server encrypts the first file key by using the first device key to generate the encrypted first file key;
transmit the encrypted first multimedia file to a communication device in the first vehicle based on a selection input;
receive a request for the first file key from the communication device; and
transmit the first file key to the communication device, wherein the processor decrypts the encrypted first file key by using the first device key to generate the first file key, and wherein the communication device decrypts the encrypted first multimedia file by using the first file key for the offline playback of the first multimedia file.

11. The system of claim 10, wherein the memory is further configured to store a plurality of encrypted multimedia files and a plurality of encrypted file keys, wherein the plurality of encrypted multimedia files include the encrypted first multimedia file and the plurality of encrypted file keys include the encrypted first file key.

12. The system of claim 10, wherein the processor is further configured to transmit the encrypted first multimedia file to the communication device through a second communication network, when a passenger rides the first vehicle.

13. The system of claim 10, wherein the first device key associated with the first control device in the first vehicle is different from a second device key of a second control device in a second vehicle.

14. The system of claim 10, wherein the processor is further configured to transmit a first identifier associated with the first multimedia file to the communication device.

15. The system of claim 14, wherein the processor is further configured to receive the selection input of the first multimedia file from the communication device based on the first identifier.

16. The system of claim 10, wherein the processor is further configured to decrypt the encrypted first file key to generate the first file key in real time.

17. The system of claim 10, wherein the communication device is offline, wherein the communication device plays the first multimedia file by way of a multimedia player, and wherein the multimedia player transmits the request to the first control device for the first file key for the offline playback of the first multimedia file.

18. The system of claim 10, wherein the server encrypts a second multimedia file by using a second file key, and wherein the first file key is different from the second file key.
